(19) United States
(12) Patent Application Publication
(10) Pub. No.: US 2011/0229721 A1
(43) Pub. Date: Sep. 22, 2011

(54) HOTMELT ADHESIVES

(75) Inventors: Martin Hoch, Shanghai (CN); Michael Herrmann, Koln (DE)

(73) Assignee: LANXESS DEUTSCHLAND GMBH, Leverkusen (DE)

(21) Appl. No.: 12/530,370

(22) PCT Filed: Sep. 11, 2008
(86) PCT No.: PCT/CN08/72338

§ 371 Date: Mar. 17, 2011

(51) Int. Cl. B32B 27/36; C09J 131/04; C09J 153/02; C09J 193/04; C09J 11/06; B32B 7/12; B32B 27/00

(52) U.S. Cl. 428/412; 525/93; 524/505; 524/271; 524/296; 524/295; 524/377; 524/314; 524/311; 156/327; 428/500; 428/480

(57) ABSTRACT

New hotmelt adhesives are provided that are based on specific ethylene-vinyl acetate copolymers, styrene block copolymers, and a tackifying resin. These hotmelt adhesives are outstandingly suitable for bonding substrates, more particularly for bonding films to substrates.

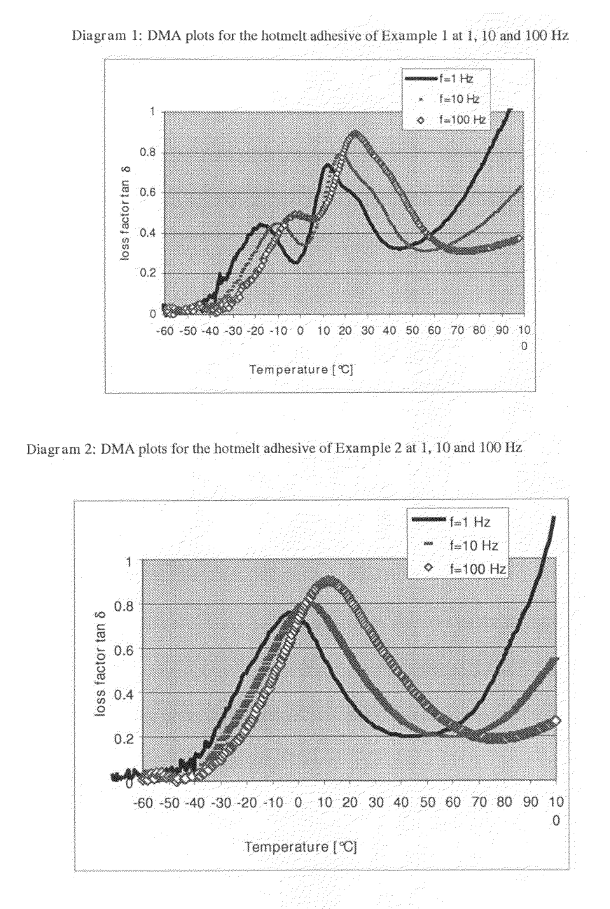

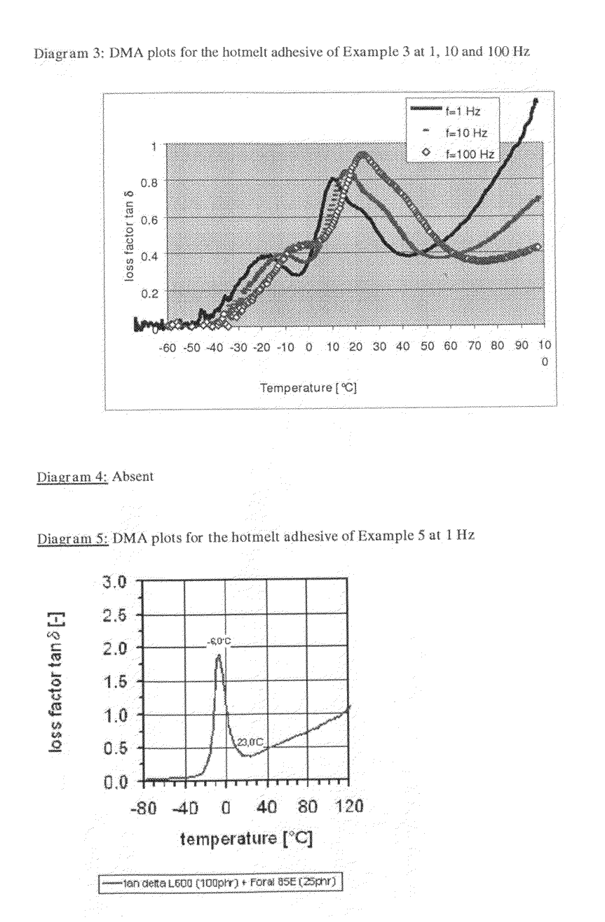

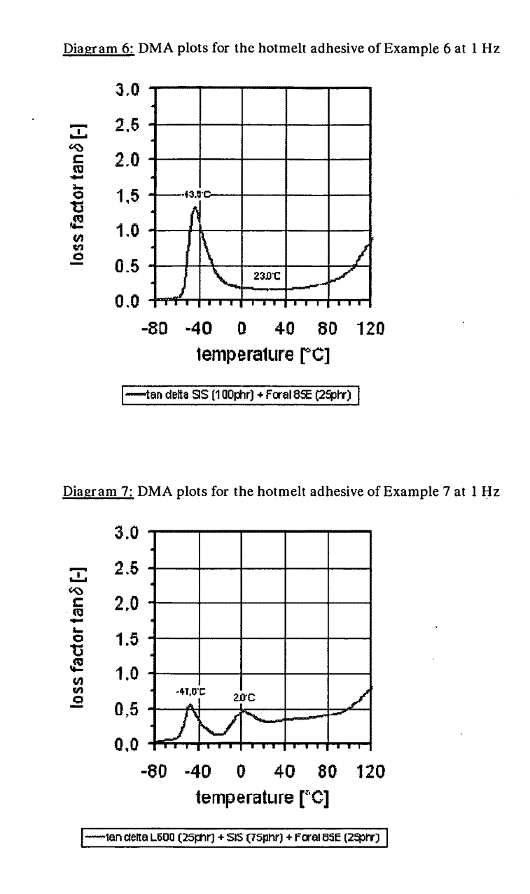

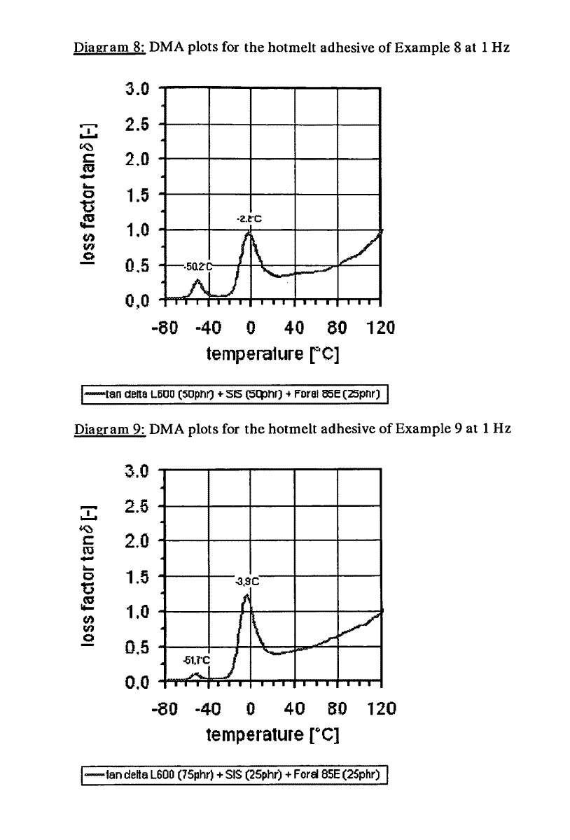

The invention relates to hotmelt adhesives and also to their preparation and use.

Hotmelt adhesives, also referred to in the art as hotmelts, are, in general, water-free and solvent-free adhesives which are solid at room temperature and which are applied from the melt to the parts or substrates to be bonded, and, after joining, set physically, with solidification, on cooling. These hotmelts are said to have good adhesion to flexible substrates and to allow visually flawless bonding of polymeric films to a very wide range of substrates.

Additionally, however, there are hotmelts which, even after cooling, remain permanently tacky and capable of adhesion. Under gentle applied pressure, these hotmelts adhere instantly to virtually all substrates, and are referred to as pressure sensitive adhesives, also in abbreviated form as “psa”. The scope of application of these hotmelt psas is very broad and may encompass not only the consumer sector but also that of industry. Of relevance in this context is, for example, the packaging industry and also the beverage industry, for labelling, for attaching transport bags or for affixing disposable articles, the objective being either permanent or temporary fixing.

Typical hotmelts are based on base polymers, tackifying resins, optionally plasticizer oils, and, optionally, various additives. Very often, use is made of styrene block copolymers, examples being styrene-isoprene-styrene block copolymers (“SIS”), styrene-butadiene-styrene block copolymers (“SBS”) and their hydrogenated variants (such as, for example, styrene-ethylene-butylene-styrene (“SEBS”) and styrene-ethylene-propylene-styrene (“SEPS”) block copolymers), but also of amorphous poly-α-olefins (APAO).

To manufacture hot melts having pronounced psa properties, use is made predominantly of styrene-isoprene-styrene (SIS) triblock copolymers, since these formulations can be used over a broad temperature range. These SIS-based hotmelt psas possess an aggressive tack—that is, after just a very short contact time, a high bond strength is attained. They make it possible, furthermore, for high peel strengths and good cohesive strength to be set. The majority of SIS-based formulations are clear and colourless and their odour is low.

More recently, availability problems in isoprene-based hotmelt psas have given rise to the desire to use, alternatively, SBS or SEBS as the base polymer. Proposals have been made, for example, to dilute or extend the SIS base polymer with SIBS (ASI Adhesives Sealant Industry, June 2005, M Peters). Furthermore, SIS types with a higher styrene fraction, in the range for example of 40% rather than the hitherto-customary 14% to 20%, have been investigated, albeit with the outcome that further formulation effort must be made in order for the end product to possess the required properties again.

It is known, furthermore, that, when SBS is used in formulations of hotmelt psas, the difficulty arises of achieving an appropriate balance between the adhesive properties and cohesive properties in coated adhesive tapes or labels. (C. Donker, RFP, 2/2006, 106). It was found that only 1:1 blends of SIS and SBS yield satisfactory results.

SEBS is not a typical hotmelt psa polymer, since its tack is unsatisfactory. On the other hand, it is generally very desirable to use polymers which have only a low double bond content. The problems resulting from the double bonds are described very clearly in U.S. Pat. No. 6,723,407: the disadvantages of such styrene block copolymers with unsaturated middle blocks lie in the low ageing stability, the relatively low stability to UV radiation, a relatively high level of heat ageing, and tendency towards ozonolysis. Furthermore, significant levels of double bonds allow only limited processing temperatures and processing times. Nor can absolutely transparent adhesives be prepared in this way, since in order to achieve the necessary UV protection it is necessary to add correspondingly protecting pigments such as TiO₂ or carbon black.

Saturated styrene block copolymers do not have this restriction, but still exhibit a relatively low binding force in formulations. Often it is necessary to use significant amounts of plasticizer oils in order to achieve the desired tack. This has the distinct disadvantage that such plasticizer oils may migrate into the substrates, and the appearance, for example, of labels is impaired drastically as a result of impregnation. In the case of bonding of a film to solid substrates, the migration of plasticizer may also result in the films, in the form of labels, for example, developing folds or waves after a certain time.

When using SEBS, the selection of suitable tackifying resins, also referred to in the art as tackifier resins, is obviously very limited. On the basis of the comments of DuBois (Adhesives & Sealants Council Meeting 2005) on the Hildebrand solution parameters, the compatibility of the middle block present in SEBS, composed of repeating units of ethylene and butylene, with the important group of the resin esters is poor.

WO-A-02/074873 describes hotmelt psas with relatively low double-bond contents based on SEPS, which, however, acquire only satisfactory adhesive properties by mixing the SEPS with SIS. Since SEPS is a hydrogenation product of SIS, furthermore, the unwanted dependence on isoprene-based raw materials is retained.

DE 10 2006 054196, furthermore, describes hotmelt adhesives based on styrene block copolymers and ethylene-vinyl acetate copolymers with a melting point above 70° C. (measured by DSC). It is said that these ethylene-vinyl acetate copolymers are crystalline or partly crystalline. Besides the styrene block copolymers and the EVA copolymers, the hotmelt adhesive must necessarily include, as additional components, a tackifying resin and also relatively large quantities of plasticizer. In the examples, mixtures of SBS with an ethylene-vinyl acetate copolymer “Evatan 28-05” with 28% by weight vinyl acetate, tackifier resin and, in turn, high amounts of plasticizer are described. This high plasticizer fraction is unwanted, as already described above. Adhesive mixtures which are free from double bonds are not described at all in DE 10 2006 054196. DE 10 2006 054196 emphasizes, as an advantage, the fact that the styrene block copolymers and the EVA that are used are compatible with one another.

Accordingly the object of the present invention was to find a polymeric additive which increases the level of adhesive of hotmelt psas based on styrene block copolymer and more particularly on SEBS. The object, further, was to provide hotmelt adhesives having improved processing and service properties which exhibit an excellent level of adhesion, very good adhesion, high ageing resistance, and, furthermore, low tendency towards migration, thus enabling visually flawless bonding of substrates and, more particularly, of films to a wide variety of substrates.

The invention provides a hotmelt adhesive for bonding substrates, comprising
a) 5 to 70 phr, preferably 10 to 60 phr, of at least one ethylene-vinyl acetate copolymer having a vinyl acetate content in the range from 40% to 90% by weight,
b) 95 to 30 phr, preferably 90 to 40 phr, of at least one styrene block copolymer, and
c) 20 to 200 phr, preferably 25 to 130 phr, of at least one tackifying resin,
   phr representing the parts by weight based on 100 parts by weight of polymer.

In relation to the figure “phr”, the reference “polymer” stands in the context of this specification for the sum total of components a) and b).

A feature of the hotmelt adhesives of the invention is that for the first time it has been possible to use blends of styrene block copolymers and ethylene-vinyl acetate copolymers with a high vinyl acetate content. The EVA copolymers employed only to date in the prior art, with a relatively low vinyl acetate content and a melting point above 70° C., lead, on the evidence of the disclosure in DE 10 2006 054196, to mixtures which do not have true psa character, since on cooling they solidify to a solid mass and can be used only in hot doctor blade application, as a result of which, among other things, practical handling takes on a more complicated form. Moreover, the use of ethylene-vinyl acetate copolymers with a low vinyl acetate content necessitates the use of relatively large quantities of plasticizer, which is not the case for the hotmelt adhesives of the invention. The hotmelt adhesives of the invention possess the desired very good level of adhesion, measured typically in the form of the peel strength in the 90° or 180° peel test, and more particularly possess very good adhesion to polar substrates. Above all, in the case of the SEBS-based hotmelt psa, the level of adhesion in the inventive blend with the ethylene-vinyl acetate copolymers is increased relatively to the known SEBS-based hotmelt psas, and adhesives are obtained which have a high ageing resistance and, moreover, a low tendency towards migration, with the consequence that visually flawless bonds are possible. Also met are the requirements concerning thermal stability and redetachability. Furthermore, the low-temperature flexibility and hence the low-temperature adhesion capacity of the hotmelt adhesives of the invention is significantly improved as compared to the adhesives from the prior art of the kind described, for example, by Dr. Noël De Keyzer and Dr. Geert Vermunicht in a presentation at AFERA 2004 (European Association for the Self Adhesive Tape Industry).

Optionally the hotmelt adhesive of the invention further comprises
d) up to 40 phr, preferably 5 to 20 phr
   of at least one paraffinic, naphthenic or aromatic plasticizer oil or plasticizer of the ester type,
      and further, optionally,
e) up to 20 phr, preferably up to 5 phr
   of one or more further additives such as ageing inhibitors, dyes or antistatic additives, for example,
      phr again representing the parts by weight based on 100 parts by weight of polymer.

It is further possible to add fillers, no particular requirements being imposed on the amount. The skilled person is aware that fillers are generally used to lessen cost and, at high levels, significantly impair the technical adhesive properties.

### Component a): Ethylene-Vinyl Acetate Copolymers

The component a) used in the hotmelt adhesive of the invention, in the form of at least one ethylene-vinyl acetate copolymer having a vinyl acetate content in the range from 40% by weight up to 90% by weight, based on the sum of the monomers, is known in principle to the skilled worker, is also abbreviated to “EVM”, and is available commercially, for example, in the form of the product range with the brand name Levamelt® from Lanxess Deutschland GmbH. With preference it is possible to use ethylene-vinyl acetate copolymers having a vinyl acetate content in the range from more than 40% by weight to 90% by weight, more preferably from 45% to 90% by weight, more preferably from 45% to 85% by weight and more particularly in the range from 50% to 70% by weight, based on the sum of the monomers. Optionally it is also possible, besides ethylene and vinyl acetate, to use further comonomers for preparing component a), in which case the above-described vinyl acetate content must continue to be met. The ethylene-vinyl acetate-copolymers and/or terpolymers to be used, based on ethylene, vinyl acetate and one or more further monomers, are typically either partially crystalline or completely amorphous. In the case of partially crystalline ethylene-vinyl acetate copolymers, the copolymers have a melting point of below 60° C. (measured by DSC). Above a vinyl acetate content of about 57% by weight, there is usually no longer any melting point found. The pure copolymers are particularly tacky when the vinyl acetate content lies between 60% and 70% by weight. The MFI value (reported with the unit [g/10 min]; measured at 190° C. and 21.1 N) of the ethylene-vinyl acetate copolymers and/or, optionally, terpolymers is typically in the range from 0.5 to 100, preferably in the range from 2 to 50.

### Component b): Styrene Block Copolymer

A further component used in the mixture according to the invention is a styrene block copolymer. The copolymers in question may be, for example, styrene and styrene-butadiene copolymers (SBS, SBR), styrene-isoprene copolymers (SIS), styrene-ethylene/butylene copolymers (SEBS), styrene-ethylene/propylene-styrene copolymers (SEPS) or styrene-isoprene-butylene copolymers (SIBS). Products of this kind are known to the skilled worker and available commercially. Preference is given to using SEBS and SEPS. SEBS styrene block copolymers, for example, are available under the brand names Kraton® G, Septon™ and Vector®.

Where SEBS is used as styrene block copolymer, it has been found appropriate for the styrene content to be in the range from 10% to 50% by weight and for the styrene block copolymer, furthermore, to be hydrogenated to an extent of at least 50%.

It is also possible, furthermore, to use mixtures of SEBS or SEPS with SBS or SIS, since they generally have good miscibility with SEBS or SEPS, respectively.

It has been found appropriate to use a styrene block copolymer which has a wholly or partly hydrogenated middle block (e.g. SEBS, SEPS or SIPS) and which can be used optionally in combination with a non-hydrogenated styrene block copolymer (e.g. SBS, SIS). Optimum ageing resistance can be achieved if the hydrogenated styrene block copolymers are predominant in such combinations.

### Component c): Tackifying Resins

The hotmelt adhesives of the invention use at least one tackifying resin. These resins are frequently also referred to within the art as “tackifier resins”. They may possess any of a wide variety of compositions, and impart an additional adhesive effect. Examples of those suitable include the following: rosin ester resins based on natural raw materials, i.e. what are known as “gum rosins”, wholly or partly hydrogenated rosin ester resins, maleinized derivatives of these rosin ester resins, disproportionated derivatives, abietic esters, modified natural resins such as resin acids from balsam resin, tall resin or wood resin, e.g. fully saponified balsam resin, optionally modified terpene resins, more particularly terpene copolymers or terpolymers such as styrene terpenes, α-methyl-styrene terpenes, phenol-modified terpene resins and also hydrogenated derivatives thereof, other styrene resins, other, optionally phenol-modified α-methyl-styrene resins, acrylic acid copolymers, preferably styrene-acrylic acid copolymers, and aromatic, aliphatic or cycloaliphatic hydrocarbon resins of the type C₅, C₉, C₉/Cₜₒ and also their modified or hydrogenated derivatives.

The tackifying resins used in the hotmelt adhesive of the invention typically possess a softening point in the range from 60 to 130° C. (measured by the ring and ball method in accordance with DIN 52011).

Typical commercial products for rosin esters include the following:
Sylvalite from Arizona Chemical such as Sylvalite RE 100, RE 104, RE 105, RE 115

Typical commercial products for hydrogenated rosin esters include the following:
Foral® from Eastman Chemical Company such as Foral® 85-E, Foral® 105-E
Foralyn® from Eastman Chemical Company such as Foralyn® 90 and Foralyn® 110
Novares® and Regalite® for hydrocarbon resins of the C₅/C₉ type, Sylvares TP for phenol-modified terpene resins.

Typical commercial products for C₉ based hydrocarbon resins include the following:
Kristalex® from Eastman Chemical Company such as Kristalex® F-100, Kristalex® F-115, Kristalex® F-85
Regalite® from Eastman Chemical Company such as Regalite® R-1100, Regalite® R-7100, Regalite® 9100, Regalite® R-5100

Typical commercial products for C₅ based hydrocarbon resins include the following:
Piccotac® from Eastman Chemical Company such as Piccotac® 1095-N, Piccotac® 7590-N

Typical commercial products for C_{9/10} based hydrocarbon resins include the following:
Novares® from Rutgers Chemicals AG such as Novares® TM 90, Novares® TNA 90, Novares® TA 100, Novares TK 100, Novares® TN 100, Novares TT 100, Novares® TN 140

Typical commercial products for a-methyl-styrene resins include the following:
Sylvares SA 100 and Salvares SA 140 from Arizona Chemical
Sylvares 600 as phenol-modified a-methyl-styrene resin from Arizona Chemical

Typical commercial products for terpene resins include the following:
Sylvares TP 105 and TR 1100 from Arizona Chemical
Sylvares TP 300 and Sylvares TP 2040 as phenol-modified terpene resin from Arizona Chemical

In the hotmelt adhesives of the invention it is preferred to use resins which do not soften the styrene end block, i.e. have a higher compatibility for the middle block of the styrene block copolymer and/or for the ethylene-vinyl acetate copolymer. It has emerged that, in this way, the styrene block is retained unchanged as a hard component, and resins of this kind contribute to the thermal stability, i.e. the retention of a certain strength or resistance to flow at elevated temperatures.

The tackifying resin or resins is or are used in an amount of 20 to 200 phr, preference being given to levels of 25 to 130 phr. Here again, phr also means parts by weight based on 100 parts by weight of polymer.

It has been found appropriate to use, in the hotmelt adhesive of the invention, a tackifier resin which is liquid at room temperature, at up to 40 phr, preferably at 5 to 30 phr, either alone or else in combination with one or more further tackifier resins, the range to be observed for the total amount of tackifier resin being that already stated, from 20 to 200 phr.

Additionally it is possible as component c) to use aromatic, aliphatic or cycloaliphatic hydrocarbon resins, or their modified or hydrogenated variants.

### Optional Component(s) d)

Besides the essential components a), b) and c), it is possible optionally to use plasticizers as components d), which lower the viscosity, additionally simplified processing, and possibly increase the tack. Suitability here is possessed by alkyl esters of aliphatic or aromatic carboxylic acids, such as adipates, sebacates, phthalates, citrates, benzoates, mellitates and aromatic sulphonates. The amount of these plasticizers should be chosen such that there is no migration into the substrates to be bonded. This can also be avoided by selecting weights of the plasticizers used that are not too small. Use may also be made of polyalkylene glycols such as polypropylene glycol or polybutylene glycol.

In a further embodiment of the present invention the hotmelt adhesive of the invention is admixed with at least one mineral oil-based plasticizer in an amount of up to 20 phr.

### Optional Component(s) e)

Optionally it is possible to add waxes in small amounts to the hotmelt adhesive, but only in an amount such that the tack at room temperature is not adversely affected.

It is possible, furthermore, to add stabilizers and antioxidants that are known to the skilled worker to the hotmelt adhesives of the invention. This, however, is not mandatory, since an important advantage of the mixtures according to the invention is that either it is possible to set low double-bond contents or else, indeed, it is possible to do entirely without the use of polymers containing double bonds. This allows the use of antioxidants to be minimized or omitted completely. Further conceivable ingredients are known to the skilled worker, such as, for example, fillers for the purpose of reducing the production cost of the hotmelt adhesives, colour pigments and adhesion promoters.

The present invention further provides a process for preparing the hotmelt adhesives of the invention, by mixing components a), b) and c) and also, optionally, d) and e) with one another. For this purpose it is possible to employ mixing techniques that are known to the skilled worker. Mixing of the components to a homogeneous melt takes place typically in a temperature range from 140 to 190° C.

The hotmelt adhesives of the invention may be produced either batchwise, as in a Z-blade mixer, for example, or else continuously, for example in an extruder, more particularly a twin-screw extruder.

The present invention further provides the use of the hotmelt adhesives of the invention to bond substrates.

The hotmelt adhesives of the invention may be used to bond a broad spectrum of different substrates. Substrates of this kind are typically solid. They may be flexible or, alternatively, rigid. Preferably one of the substrates to be bonded is thin and flexible, in the form more particularly of films, multi-layer films, paper or multi-layer constructions from paper and polymer films. Examples of such include labels, pack surrounds or bags. They may be made, for example, of plastics such as polyethylene, polypropylene, polystyrene or polyvinyl chloride. Labels, however, may also be based on paper, where appropriate in combination with polymer films. Particularly when the substrates in question are based on a polyolefin, the bond strength may be set in such a way that redetachment and rebonding are possible.

A suitable second substrate, bonded by the hotmelt adhesives of the invention to the first substrate, includes, for example, glass, metal, painted or unpainted surfaces, coated or untreated paper, cardboard packaging, thermoplastics, preferably of polycarbonate, polyester, PVC, polystyrene, SAN, ABS, polypropylene (PP), polyethylene or EVA (ethylene-vinyl acetate copolymers having a vinyl acetate content of greater than 0% to less than 40% by weight).

Particular preference is also given to the use of the hotmelt adhesives of the invention for rereversible bonding of two thin flexible substrates. By this means it is possible for film pouches to be reclosably bonded, for example.

The invention further provides the bonded, preferably reversibly bonded, substrates comprising the hotmelt adhesive of the invention.

### EXAMPLES

The examples below used the following substances:

### Levamelt® 600 (Component a)

Ethylene-vinyl acetate copolymer with a vinyl acetate content of 60% by weight; Lanxess Deutschland GmbH

### Kraton® G 1657 (Component b)

SEBS polymer with a styrene content of 13% and a melt flow index of 8 g/10 min (200° C., 50 N); Kraton Polymers

### Kraton® D 1161 (Component b)

SIS polymer with a styrene content of 15% and a melt flow index of 12 g/10 mm (200° C., 50 N); Kraton Polymers

### Rosin Ester Foral® 85 E (Component c)

Hydrogenated rosin ester with an R&B value of 85° C.; Arizona Chemical

### Liquid Rosin Ester Resin RL-1 (Component c)

### Deqing Yinlong Industrial Co., Ltd, P R China

### Kristallex™ F-85 (Component c)

C₉ hydrocarbon resins; Eastman Chemical Company

### Irganox® 1010 (Component e)

### Stabilizer; Ciba Geigy

### Sunpar® 2280 (Component e)

Paraffin oil, produced by Sunoco, available, for example, through Natrochem, Inc.

### Preparation of the Mixtures:

The formula ingredients indicated below for the individual examples were melted and mixed at 170° C. and 180 rpm in a mini-mixer (DSM Midi-Mixer with 15 ml working volume, twin-screw extruder) in 5 minutes. The mixture was subsequently discharged via a nozzle and cooled on silicone paper.

The following investigations were carried out on the resulting hotmelt adhesives:

### 1. DMA Measurement

A Mettler-Toledo DMA/SDTA861e instrument was used with a double sandwich sample holder. The DMS measurements were conducted in each case at a frequency of 1, 10 and 100 Hz, with a heating rate of 1 K/min, and with a maximum deformation amplitude of 0.1%.

The results for the examples of the present specification are set out in Tables 1 and 2 below and also in diagrams 1 to 3 and also 5 to 9.

### 2. Peel Test

The adhesive mixture of Examples 1 to 4 was applied to a PET backing film with a layer thickness of approximately 50 μm, corresponding to a coat weight of 50 g/m². The bonding of the PET film thus coated to the respective substrate, in the form of a V2A stainless steel plate or a polycarbonate plate, took place in a film laminator at 100° C. for a time of 3 seconds. The peel force was subsequently determined, after 24-hour storage under standard conditions, i.e. at room temperature (corresponding to 22° C.+/−2° C.), by means of a peel test in accordance with FINAT test method No. 1. This test involved a bond strength test in a 180° peel test with a peel speed of 300 mm/min and a test strip of dimensions 25 mm×200 mm. In each case, three experiments were carried out per hotmelt adhesive. The results of these three experiments are set out for each example in Table 1 below.

### Example 1-4

### SEBS as Styrene Block Copolymer

### Example 1

A mixture was prepared from:

| | |
|---|---|
| 2.79 g | EVM Polymer (Levamelt ® 600) |
| 4.18 g | SEBS Polymer (Kraton ® G 1657) |
| 6.69 g | Resin (Rosin Ester Foral ® 85 E) |
| 0.07 g | Stabilizer (Irganox ® 1010) |

### Example 2 (Comparative)

A mixture was prepared from:

| | |
|---|---|
| 6.97 g | SEBS Polymer (Kraton ® G 1657) |
| 6.69 g | Resin (Rosin Ester Foral ® 85 E) |
| 0.07 g | Stabilizer (Irganox ® 1010) |

### Example 3

A mixture was prepared from:

| | |
|---|---|
| 2.46 g | EVM Polymer (Levamelt ® 600) |
| 3.70 g | SEBS Polymer (Kraton ® G 1657) |
| 6.16 g | Resin (Rosin Ester Foral ® 85 E) |
| 0.62 g | Liquid rosin ester resin (RL-1) |
| 0.07 g | Stabilizer (Irganox ® 1010) |

### Example 4

A mixture was prepared from:

| | |
|---|---|
| 2.15 g | EVM Polymer (Levamelt ® 600) |
| 3.22 g | SEBS Polymer (Kraton ® G 1657) |
| 5.7 g | Resin (Rosin Ester Foral ® 85 E) |
| 0.07 g | Stabilizer (Irganox ® 1010) |
| 2.15 g | Liquid paraffin (Sunpar ® 2280) |

TABLE 1
Results of the DMA investigations and of the peel test for Examples 1 to 4

| Example | | | |
|---|---|---|---|
| 1 | 2 | 3 | 4 |
| (inventive) | (comparative) | (inventive) | (inventive) |

Peel test*

| | | | | |
|---|---|---|---|---|
| V2A steel | 52.37/58.87/54.58 | 33.8/41.6/41.2 | 53.6/52.6/56.1 | 25.9/21.8/25.8 |
| Polycarbonate | 54.3/58.3/60.8 | 48.1/44.4/46.6 | 56.8/55.6/49.1 | 29.0/29.8/28.7 |

DMA investigations

| | | | | |
|---|---|---|---|---|
| DMA | two phases | one phase at | two phases at | two phases at −10° C. |
| at 1 Hz | at −18° C. | +13° C. | −20° C. | and +10° C. (less |
| | and +13° C. | | and +10° C. | pronounced) |

*The measurements reported for the peel test are the peel forces, with the unit [N/25 mm]

### Diagrams 1-3

Diagrams 1-3 show the DMA plots for the hotmelt adhesive of Examples 1, 2 and 3, in each case at a frequency of 1, 10 and 100 Hz, as a plot of the loss factor tan δ as a function of the temperature.

Surprisingly it has been found that the inventive formulation of SEBS and EVM has a pronounced 2-phase nature. Although the glass transition temperature Tg of pure SEBS, at −45° C. (DMA, 2 Hz, Carvagno et al, presentation at the PSTC, 16-18 May 2007, Orlando, Fla., U.S.A.), is below that of the EVM used (Tg at about −20° C.), when blended with EVM, a low-temperature phase appears in the vicinity of −18° C., and a phase at +13° C., which by means of the comparative experiment, 2, can be identified as the “EB” middle-block phase of the SEBS.

Glass transition ranges are typically correlated with the temperature range of tack. Glass transition ranges close to room temperature are clearly favourable for adhesive applications at room temperature or slightly elevated temperature. In the case of target applications at low temperature, such as labels for refrigeration packaging, for example, the hotmelt adhesives ought to have glass transition ranges below 0° C. This can be achieved, in accordance with the prior art, by means, for example, of mixtures of SIS with tackifier resins which exhibit compatibility with the SIS middle block. In that case, however, the cohesive bond strength at room temperature is less pronounced, and the usefulness, accordingly, is restricted. In contrast to this, the hotmelt adhesives of the invention can be used both at room temperature and at low temperatures.

Examples 3 and 4 show that the two-phase nature is retained when liquid resins or plasticizers are added, albeit at a somewhat less pronounced level when using paraffinic oils, as in Example 4. Particularly appropriate, therefore are hotmelt adhesives in which nonpolar oils are used, at the most, in very small amounts. Liquid resins, especially those of the rosin ester type, shift the glass transition ranges of the two phases to lower temperatures and are therefore a means of increasing the tack at lower temperatures.

### Examples 5-9

### SIS as Styrene Block Copolymer

### Example 5: (Comparative)

A mixture was prepared from:

| | |
|---|---|
| 100 phr | EVM polymer (Levamelt ® 600) |
| 33.33 phr | Kristallex ™ F-85 |

### Example 6: (Comparative)

A mixture was prepared from:

| | |
|---|---|
| 100 phr | Kraton ® D 1161 |
| 33.33 phr | Kristallex ™ F-85 |

### Example 7: (Inventive)

A mixture was prepared from:

| | |
|---|---|
| 25 phr | EVM polymer (Levamelt ® 600) |
| 75 phr | Kraton ® D 1161 |
| 33.33 phr | Kristallex ™ F-85 |

### Example 8: (Inventive)

A mixture was prepared from:

| | |
|---|---|
| 50 phr | EVM polymer (Levamelt ® 600) |
| 50 phr | Kraton ® D 1161 |
| 33.33 phr | Kristallex ™ F-85 |

### Example 9: (Inventive)

A mixture was prepared from:

| | |
|---|---|
| 75 phr | EVM polymer (Levamelt ® 600) |
| 25 phr | Kraton ® D 1161 |
| 33.33 phr | Kristallex ™ F-85 |

The mixtures of Examples 5 to 9 were prepared by mixing the components in a kneading chamber at 90° C. for a period of about 5 minutes.

The DMA investigations and also the peel test, as already outlined for Examples 1-4, were carried out on the resulting hotmelt adhesives of Examples 5-9. The DMA investigation was carried out exclusively at a frequency of 1 Hz. In the peel test, the lamination to steel or polycarbonate took place at 80° C. All of the other measurement parameters were unchanged.

The results are set out in Table 2 below. The results of the DMA measurements are found, in addition, in diagrams 5-9.

TABLE 2
Results of the DMA investigations and of the peel test for Examples 5 to 9

| Example | | | | |
|---|---|---|---|---|
| 5 | 6 | 7 | 8 | 9 |
| (comparative) | (comparative) | (inventive) | (inventive) | (inventive) |

Peel test*

| | | | | | |
|---|---|---|---|---|---|
| V2A steel | 29.1 | 12.8 | 25.2 | 23.5 | 23.6 |
| Polycarbonate | 57.7 | 22.3 | 40.1 | 31.2 | 37.2 |

DMA investigation

| | | | | | |
|---|---|---|---|---|---|
| DMA | one phase at | one phase at | two phases | two phases | two phases |
| at 1 Hz | −6° C. | −43.5° C. | at −47° C. | at −50.2° C. | at −51.7° C. |
| | | | and +2° C. | and −2.2° C. | and −3.9° C. |

*The measurements reported for the peel test are the peel forces, with the unit [N/25 mm]

### Diagrams 5-9

Diagrams 5-9 show the DMA plots for the hotmelt adhesive of Examples 5-9, in each case at a frequency of 1 Hz, as a plot of the loss factor tan δ as a function of the temperature.

From Inventive Examples 7 to 9 it is apparent, surprisingly, that, when an inventive hotmelt adhesive based on SIS and EVM (Levamelt® 600) is prepared, again a two-phase system is formed. This is all the more surprising given that, in the case of the two comparative examples, 5 and 6, it can be seen that the tackifier resin used is obviously compatible with both components, SIS and EVM, and hence the obvious conclusion would have been that the blending of both components would give only one phase in the DMA measurement.

1. Hotmelt adhesive for bonding substrates, comprising
a) 5 to 70 phr, preferably 10 to 60 phr, of at least one ethylene-vinyl acetate copolymer having a vinyl acetate content in the range from 40% to 90% by weight,
b) 95 to 30 phr, preferably 90 to 40 phr, of at least one styrene block copolymer, and
c) 20 to 200 phr, preferably 25 to 130 phr, of at least one tackifying resin,
phr representing the parts by weight based on 100 parts by weight of polymer.

2. Hotmelt adhesive for bonding substrates according to claim 1, use being made as component a) of at least one ethylene-vinyl acetate copolymer having a vinyl acetate content of more than 40% by weight to 90% by weight, preferably in the range from 45% to 90% by weight, more preferably in the range from 45% to 85% by weight, and more particularly in the range from 50% to 70% by weight.

3. Hotmelt adhesive for bonding substrates according to claim 1 or 2, further comprising
d) up to 40 phr, preferably 5 to 20 phr, of at least one paraffinic, naphthenic or aromatic plasticizer oil or plasticizer of the ester type, and
e) up to 20 phr, preferably up to 5 phr, of one or more further additives selected from the group consisting of ageing inhibitors, dyes or antistatic additives,
phr representing the parts by weight based on 100 parts by weight of polymer.

4. Hotmelt adhesive for bonding substrates according to one or more of claims 1 to 3, comprising as component b) at least one styrene and styrene-butadiene copolymer (SBS, SBR), styrene-isoprene copolymer (SIS), styrene-ethylene/butylene copolymer (SEBS), styrene-ethylene/propylene-styrene copolymer (SEPS) or styrene-isoprene-butylene copolymer (SIBS).

5. Hotmelt adhesive for bonding substrates according to one or more of claims 1 to 3, comprising as component b) at least SEBS which possesses a styrene content in the range from 10% to 50% by weight and in which at least 50% of the C═C double bonds present in the original block copolymer are hydrogenated.

6. Hotmelt adhesive for bonding substrates according to one or more of claims 1 to 3, comprising as component b) a mixture of SEBS or SEPS with SBS or SIS.

7. Hotmelt adhesive for bonding substrates according to one or more of claims 1 to 6, comprising as component c) rosin ester resins based on natural raw materials, wholly or partly hydrogenated rosin ester resins, maleinized derivatives of these rosin ester resins, disproportionated derivatives, abietic esters, modified natural resins such as resin acids from balsam resin, tall resin or wood resin, more particularly fully saponified balsam resin, optionally modified terpene resins, more particularly terpene copolymers or terpolymers preferably styrene terpenes, α-methyl-styrene terpenes, phenol-modified terpene resins and also hydrogenated derivatives thereof, further styrene resins, other, optionally phenol-modified α-methyl-styrene resins, acrylic acid copolymers, preferably styrene-acrylic acid copolymers, and aromatic, aliphatic or cycloaliphatic hydrocarbon resins of the type C₅, C₉, C₉/C₁₀ and also their modified or hydrogenated derivatives.

8. Hotmelt adhesive for bonding substrates according to one or more of claims 1 to 7, comprising as component c) at least one tackifying resins having a softening point in the range from 60 to 130° C. (measured by the ring and ball method in accordance with DIN 52011).

9. Hotmelt adhesive for bonding substrates according to one or more of claims 3 to 8, comprising as component d) at least one alkyl ester of aliphatic or aromatic carboxylic acids, preferably adipates, sebacates, phthalates, citrates, benzoates, mellitates, aromatic sulphonates, polyalkylene glycols, preferably polypropylene glycol or polybutylene glycol, or at least one mineral oil-based plasticizer.

10. Process for preparing the hotmelt adhesives according to one or more of claims 1 to 9, components a), b) and c) and optionally d) and e) being mixed with one another in a temperature range in the range from 140 to 190° C.

11. Use of the hotmelt adhesives according to one or more of claims 1 to 9 to bond substrates.

12. Use of the hotmelt adhesives according to claim 11, one of the substrates to be bonded being thin and flexible and being preferably a film, multi-layer film, paper or a multi-layer construction from paper and polymer film(s).

13. Use of the hotmelt adhesives according to claim 11 or 12, one of the substrates to be bonded being selected from the group consisting of metal, painted or unpainted surfaces, coated or untreated paper, cardboard packaging, thermoplastics, preferably of polycarbonate, polyester, PVC, polystyrene, SAN, ABS, polypropylene (PP), polyethylene or EVA (ethylene-vinyl acetate copolymers having a vinyl acetate content of greater than 0% to less than 40% by weight). suitable. Also possible, however, is the bonding of two flexible film substrates.

14. Use of the hotmelt adhesives according to claim 11 or 12, two substrates being bonded to one another reversibly, preferably in the form of two thin flexible substrates.

15. Bonded substrates, preferably reversibly bonded substrates, comprising a hotmelt adhesive according to one or more of claims 1 to 9.
